(19) United States
(12) Patent Application Publication
(10) Pub. No.: US 2005/0193030 A1
(43) Pub. Date: Sep. 1, 2005

(54) File management method

(76) Inventor: Tomoyuki Abe, Saijo-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/066,235

(22) Filed: Feb. 25, 2005

(30) Foreign Application Priority Data
Feb. 26, 2004 (JP) 2004-052233

(51) Int. Cl. G06F 17/30

(52) U.S. Cl. 707/200

(57) ABSTRACT

In a file management method, a management entry is recorded in a predetermined position, and creation or deletion of a file is carried out. During file creation or deletion, data relating to the management entry and a file deletion destination entry of a file to be deleted or a file creation destination entry of a file to be created are updated, whereby the latest link is created among the management entry, the deletion entry, and the unused entry. So, even when a deletion entry or an unused entry is located in a backward position in the directory, these entries can be speedily detected during file formation regardless of the number of files.

### FIELD OF THE INVENTION

The present invention relates to a file management method for recording media to be used in digital cameras or the like and, more particularly, to a file management method that is suitable for cases where a great number of files exist in a directory.

### BACKGROUND OF THE INVENTION

There is a FAT (File Allocation Table) file system as a commonly used file system (refer to JIS X 0605-1990 for further information (JIS: Japanese Industrial Standards)). The whole area of a disk is divided into small units called sectors, and reading/writing of data is carried out in sector units. The file system combines continuous 2ⁿ pieces of sectors as a unit called a cluster, and manages the sectors in cluster units.

The FAT is a kind of a table in which elements (FAT entries) which one-to-one correspond to all clusters assigned to a data area are arranged in sequence. The FAT is, so to speak, a map indicating which file is actually recorded in which cluster.

In the FAT file system, when creating a file, the data area is searched for an unused entry (hereinafter referred to as an empty entry), and it is used as an entry of a file to be created. For this purpose, it is necessary to check the entries in sequence from a head entry. However, when there are many files in the directory, many entries must be checked, and it takes much time to obtain an empty entry.

On the other hand, in DCF standards (refer to JEIDA-49-2-1998 for detail (JEIDA: Japan Electronics and Information Technology Industries Association)), the file names of recorded images are given file numbers to manage the files in the order in which the images are shot, whereby file retrieval in the shooting order is facilitated.

Since the conventional file management method is constructed as described above, in the above-mentioned empty entry retrieval, when an empty entry is located in a rearward position in the directory, it takes much time to find the empty entry.

Furthermore, in the file management based on the DCF standards, deletion of an image file causes an unassigned number in the file numbers, resulting in a possibility that a file of file number “N” is not a file that is shot in Nth shooting. Further, when an unassigned number occurs, the unassigned number is eliminated by performing reassignment of file numbers. For example, when a file of file number “1” is deleted, it is necessary to rename the file names of all the files having file numbers “2” and larger, resulting in increased processing time and increased processing load.

### SUMMARY OF THF INVENTION

The present invention is made to solve the above-described problems and has for its object to provide a file management method by which an empty entry can be speedily detected even when the empty entry is located in a backward position in a directory.

It is another object of the present invention to provide a file management method by which files can be easily and speedily checked in a predetermined order, and the number of files to be renamed when a file is deleted can be reduced to 2 at maximum, regardless of the number of files in the directory.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided a file management method for managing data stored in a storage medium in file units each having a hierarchical structure called a directory, and managing the data using entries which provide a map indicating files in the directory and physical positions of subdirectories on the storage medium; wherein, in a part of an area assigned to an empty entry, link information indicating the position of another empty entry is recorded. Therefore, it is possible to speedily perform retrieval of an empty entry regardless of the number of files in the directory.

According to a second aspect of the present invention, there is provided a file management method for managing data stored in a storage medium in file units each having a hierarchical structure called a directory, and managing the data using entries which provide a map indicating files in the directory and physical positions of subdirectories on the storage medium; wherein the name of a file indicates link information to entries of files which are located before and after the file in the order in which the files are retrieved. Therefore, it is possible to speedily obtain files in predetermined order. Further, since the number of files which need renaming when deleting a file does not depend on the number of files in the directory, the process of renaming can be speedily completed.

According to a third aspect of the present invention, in the file management method according to the first aspect, information indicating the position of a head empty entry is recorded in a predetermined entry area.

According to a fourth aspect of the present invention, in the file management method according to the second aspect, information indicating the position of an entry of a head file is recorded in a predetermined entry area.

According to a fifth aspect of the present invention, in the file management method according to the third aspect, a format in which the information indicating the position of the head empty entry in the predetermined entry area has compatibility with a FAT file system based on JIS-X-0605.

According to a sixth aspect of the present invention, in the file management method according to the third aspect, the position information and the link information are updated when a file is created on or deleted from the storage medium.

According to a seventh aspect of the present invention, in the file management method according to the third aspect, when a directory is created on the storage medium, the information indicating the position of the head empty entry is recorded in the directory.

According to an eighth aspect of the present invention, in the file management method according to the fourth aspect, when a directory is created on the storage medium, the position information indicating the position of the entry of the head file is recorded in the directory.

According to a ninth aspect of the present invention, in the file management method according to the fourth aspect, the position information and the link information are updated when a file is created on or deleted from the storage medium.

### BRIEF DESCRIPTION OF THE DRAWINGS

FIG. 1(a) is a diagram illustrating a data structure of an entry in a file management method according to a first embodiment of the present invention.

FIG. 1(b) is a diagram illustrating a data structure of an entry in the file management method according to the first embodiment of the present invention.

FIG. 1(c) is a diagram illustrating a data structure of an entry in the file management method according to the first embodiment of the present invention.

FIG. 2 is a diagram illustrating an entry structure immediately after directory creation in the file management method according to the first embodiment.

FIG. 3 is a flowchart illustrating an entry updation process to be performed during file formation in the file management method according to the first embodiment.

FIG. 4 is a diagram illustrating an entry structure obtained when a file is created in the directory shown in FIG. 2.

FIG. 5 is a diagram illustrating an entry structure obtained when another file is created in the directory shown in FIG. 4.

FIG. 6 is a flowchart illustrating an entry updation process to be performed during file deletion in the file management method according to the first embodiment.

FIG. 7 is a diagram illustrating an entry structure obtained when a file is deleted from the direction shown in FIG. 5.

FIG. 8 is a diagram illustrating an entry structure obtained when a file is deleted from the directory shown in FIG. 7.

FIG. 9 is a diagram illustrating an entry structure obtained when a file is created in the directory shown in FIG. 8.

FIG. 10 is a diagram illustrating a data structure of an entry of a retrieval target file in a file management method according to a second embodiment of the present invention.

FIG. 11 is a diagram illustrating an entry structure immediately after directory creation in the file management method according to the second embodiment.

FIG. 12 is a flowchart illustrating an entry updation process to be performing during file creation according to the second embodiment.

FIG. 13 is a diagram illustrating an entry structure obtained when a file is created in the directory shown in FIG. 11.

FIG. 14 is a diagram illustrating an entry structure obtained when another file is created in the directory shown in FIG. 13.

FIG. 15 is a diagram illustrating an entry structure obtained when another file is created in the directory shown in FIG. 14.

FIG. 16 is a flowchart illustrating an entry updation process to be performed during file deletion in the file management method according to the second embodiment.

FIG. 17 is a diagram illustrating an entry structure obtained when a file is deleted from the directory shown in FIG. 15.

FIG. 18 is a diagram illustrating an entry structure obtained when a file is deleted from the directory shown in FIG. 17.

FIG. 19 is a flowchart illustrating a file retrieval process in the file management method according to the second embodiment.

FIG. 20 is a diagram illustrating a data structure of a management entry in a file management method according to a third embodiment of the present invention.

### DETAILED DESCRIPTION OF THE PREFERRED EMBODIMENTS

### Embodiment 1

Since a file management method according to a first embodiment of the present invention is realized on the FAT file system based on the JIS-X-0605, initially two entries to be used for this first embodiment will be briefly described, among entries defined in the FAT file system.

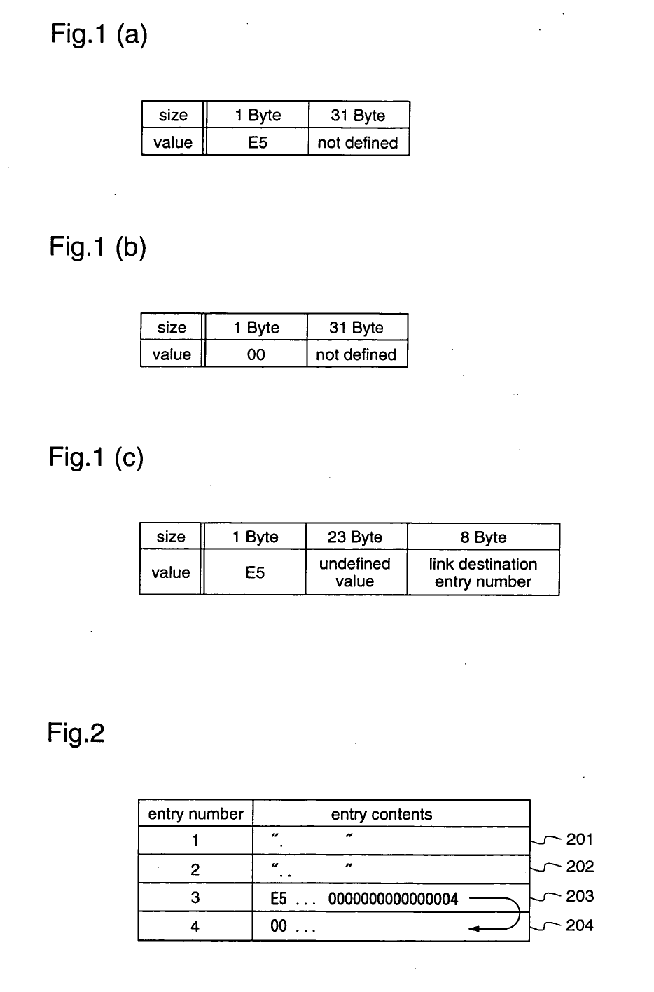

One of the two entries is a deletion entry, which is defined such that 1 byte of data at the beginning is E5, and the contents of remaining 31 bytes of data are ignored, as shown in FIG. 1(a). The other entry is an unused entry, which is defined such that 1 byte of data at the beginning is 0, and the contents of remaining 31 bytes of data are ignored.

A deletion entry according to the first embodiment has a data structure in which, as shown in FIG. 1(c), a link destination entry number indicating position information of another deletion entry or a final entry in a target directory is recorded in the final 8 bytes of a deletion entry area of the FAT file system.

Further, a deletion entry is located every time in a predetermined position in the target directory, and a link destination entry number indicating position information of another deletion entry in the directory is also recorded in the final 8 bytes of this deletion entry area (hereinafter this deletion entry is referred to as a management entry). When there is no deletion entry other than the management entry in the directory, the entry number of the final entry is recorded in the link destination entry number in the management entry.

According to the link entry numbers recorded in the respective entries, a link is created from the management entry to the final entry, including all the deletion entries other than the management entry. The process of creating the link will be described in steps from directory creation.

FIG. 2 shows the entry structure immediately after creation of a directory. A first entry 201 is a subdirectory identifying entry, and a second entry 202 is a parent directory indicating entry. A third entry is a management entry 203, and an entry number “4” of a final entry 204 is recorded in a link destination entry number in the management entry.

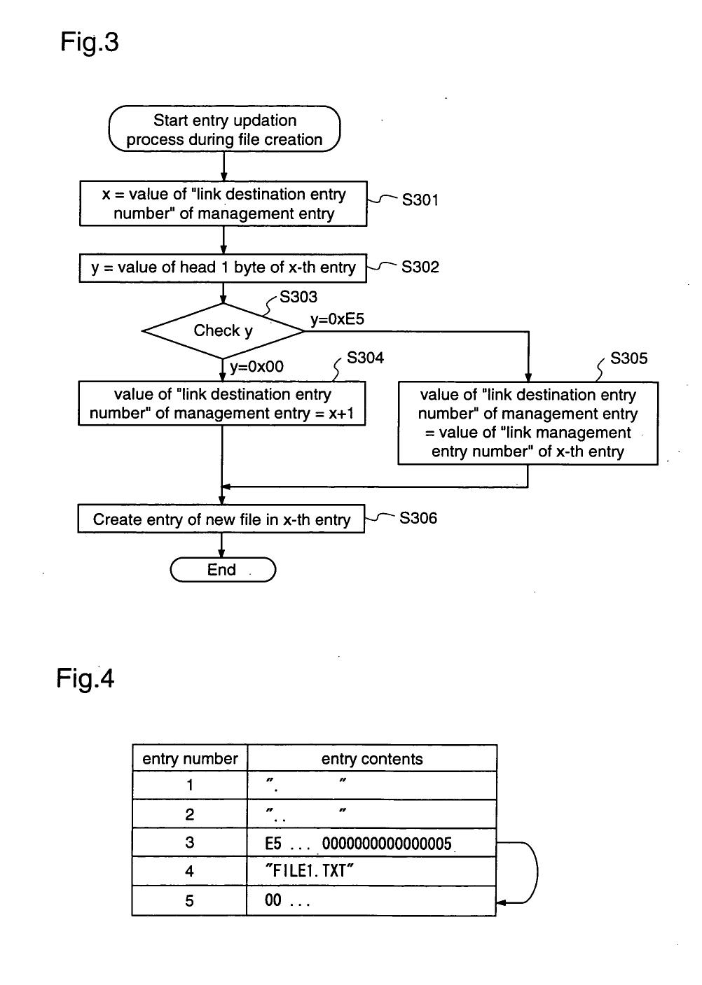

FIG. 3 is a flowchart illustrating an entry updation process to be carried out during file creation. In this first embodiment, a file is created in the directory shown in FIG. 2 using the procedure shown in FIG. 3.

When file creation is started, the link destination entry number in the management entry (third entry) is obtained (step S301). Next, the value of the first 1 byte in the obtained link destination entry is obtained (step S302), and it is judged, from the obtained value, whether the link destination of the management entry is the final entry or not (step S303).

In this case, since it is the final entry (y=0x00), the link destination entry number in the management directory is incremented by 1 (step S304). Finally, the entry of the created file is recorded in the entry indicated by the link destination entry number obtained in step S301 (step S306).

FIG. 4 shows the entry structure after the above-mentioned file creation.

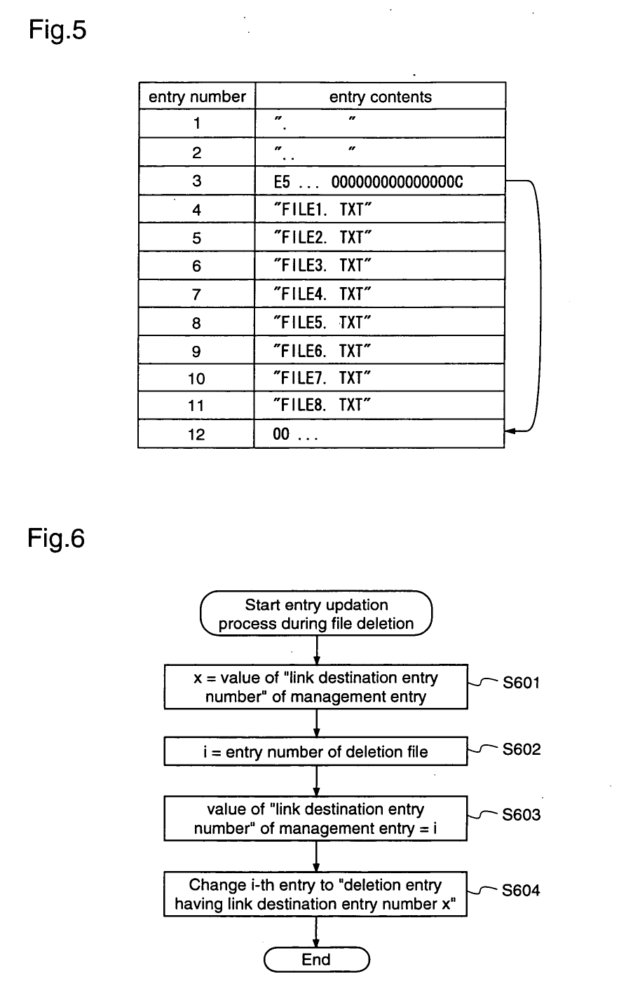

FIG. 5 shows the state where eight files are created in total by repeating the procedure shown in FIG. 3 more seven times. In this state, since no deletion entry exists, the link destination entry number (000000000000000C) indicates the final entry (entry number “12”).

FIG. 6 is a flowchart illustrating an entry updation process to be carried out during file deletion. As shown in FIG. 6, when file deletion is started, the link destination entry number in the management entry is obtained (step S601), and the entry number assigned to the deletion target file is obtained (step S602).

Next, the link destination entry number in the management entry is changed to the entry number obtained in step S602 (step S603). Finally, the contents of the entry assigned to the deletion target file is changed to a deletion entry, and the number obtained in step S601 is recorded in the link destination entry number in the deletion entry (step S604).

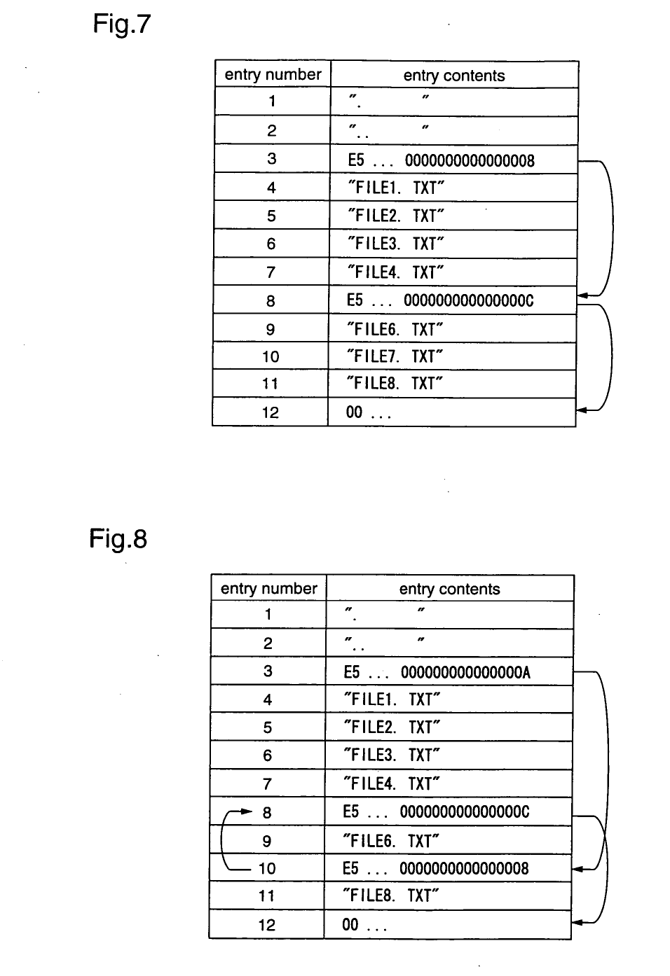

FIG. 7 illustrates the entry structure which is obtained after the file of the eighth entry shown in FIG. 5 is deleted. Since the file of the eight entry is deleted, the link destination entry number in the management entry (entry number “3”) indicates “8” (0000000000000008), and the link destination entry number in the deletion entry of the entry number “8” as a link destination indicates “12” that is the entry number of the final entry (000000000000000C).

FIG. 8 illustrates the entry structure in the case where another file is deleted from the state of FIG. 7 according to the procedure shown in FIG. 6. Since the file of entry number “10” is deleted, the link destination entry number in the management entry (entry number “3”) is changed to “10” (000000000000000A), and the link destination entry number in the deletion entry of entry number “10” newly presents the entry number “8” which has previously been the link destination entry number in the management entry of entry number “3”.

Next, creation of a file in the directory shown in FIG. 8 will be described with reference to FIG. 3. When file creation is started, the link destination entry number (000000000000000A) in the management entry (third entry) is obtained (step S301). Next, the value of the first 1 byte in the obtained link destination entry is obtained (step S302), and it is judged whether the value is the final entry or not (step S302). In this case, since it is a deletion entry (y=0xE5), the link destination entry number (000000000000000A) in the management entry (entry number “3”) is changed to the link destination entry number (0000000000000008) in the deletion entry (step S305).

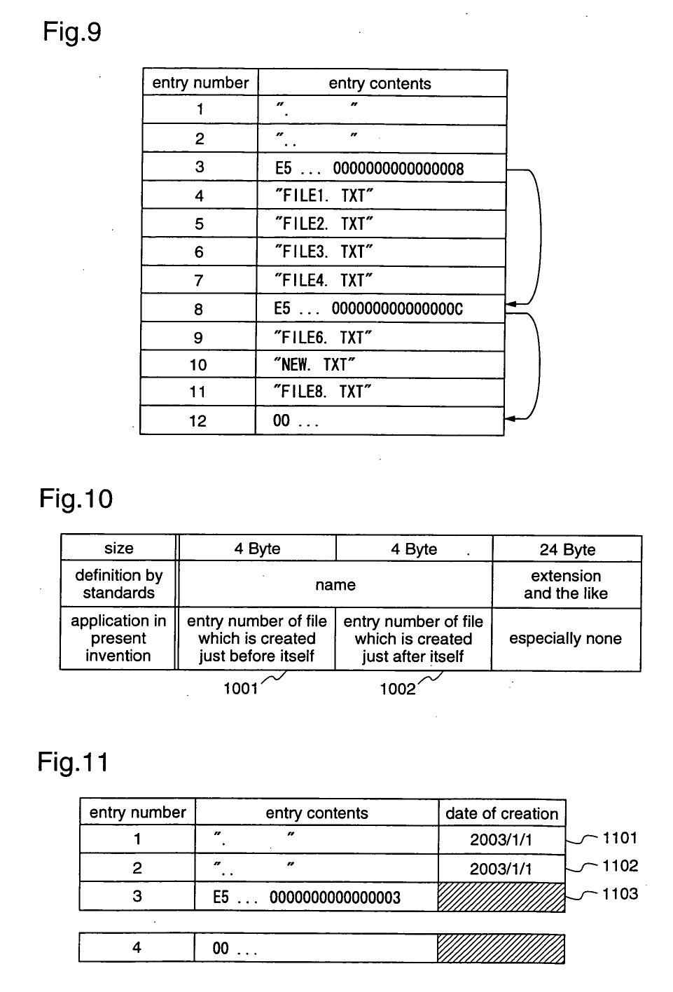

Finally, the entry of the created file is recorded in the entry (entry number “10”) indicated by the link destination entry number obtained in step S301 (step S306). The entry structure after the file creation is shown in FIG. 9.

As described above, in the file management method according to the first embodiment, the management entry 203 is recorded in a predetermined position, and creation or deletion of a file is executed according to the procedure shown in FIG. 3 or 6, respectively. Thereby, when creating or deleting a file, data relating to the management entry 203 and a file deletion destination entry of a file to be deleted or a file formation destination entry of a file to be created are updated, whereby the latest link among the management entry 203, the deletion entry, and the unused entry is created. Since the address of the next empty entry is recorded in 2nd and subsequent bytes of the management entry, when detecting an empty entry, the next empty entry can be speedily retrieved by reading only the management entry 203 of entry number “3”. Therefore, even when a deletion entry or an unused entry is located in a backward position in the directory, these entries can be speedily detected when creating a file regardless of the number of files.

### Embodiment 2

Next, a file management method according to a second embodiment of the present invention will be described. In this second embodiment, target files can be speedily retrieved in sequence of date. The file management method according to the second embodiment is implemented on the FAT file system based on the JIS-X-0605 like the first embodiment. Also in this second embodiment, a deletion entry is constantly located in a predetermined position in a target directory, and the entry number of the oldest file among retrieval target files in the corresponding directory is recorded in final 8 bytes in the deletion entry area (hereinafter this deletion entry is referred to as a management entry). When there is no retrieval target file in the directory, an entry number of the management entry itself is recorded in the management entry.

FIG. 10 shows a data structure of an entry of a retrieval target file according to the second embodiment. In the FAT file system assumed for this second embodiment, a file name excluding an extension is recorded in an area corresponding to the first 8 bytes of an entry. In this second embodiment, the entry number of a file which has been created immediately before the entry is recorded in a first 4-byte area (1001) in the 8-byte area, and the entry number of a file which has been created immediately after the entry is recorded in a subsequent 4-byte area (1002). However, the entry number of the newest file is recorded in a first 4-byte area of the name of the oldest file, and the entry number of the oldest file is recorded in a subsequent 4-byte area of the name of the newest file.

As described above, two kinds of information, i.e., the entry number of an old file and the entry number of a new file, are recorded in the name of each retrieval target file, a reciprocal link is created between the files in sequence of date. Further, since the entry number of the oldest file is recorded in the management entry, a link is also created between the management entry and the retrieval target file. The processes of creating these links will be described step by step from directory creation.

FIG. 11 shows the entry structure immediately after directory creation. In FIG. 11, the first entry (1101) is a subdirectory identifying entry, and the second entry (1102) is a parent directory indicating entry. The third entry is a management entry (1103), and “3” is recorded in the link destination entry number of the management entry because no retrieval target file exists at this point in time.

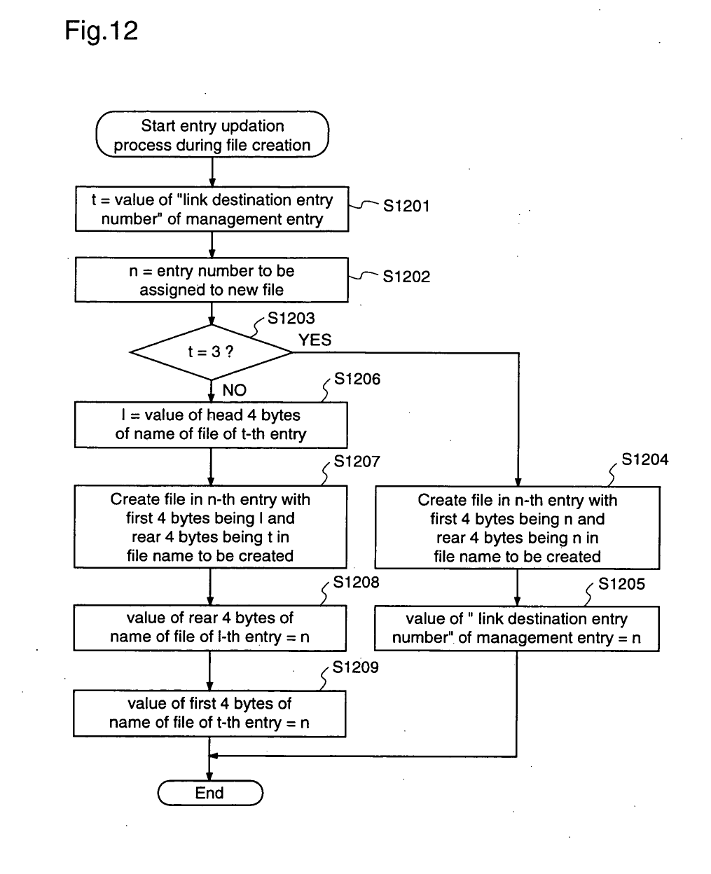

FIG. 12 is a flowchart illustrating an entry updation process to be performed during file creation. The purpose of performing entry updation in the procedure shown in FIG. 12 is to maintain the above-mentioned two links, i.e., a reciprocal link between the files and a link between the management entry and the target file. Hereinafter, an entry updation process in the case of creating a file in the directory shown in FIG. 11 will be described with reference to FIG. 12.

When file creation is started, the link destination entry number in the management entry (third entry) is obtained (step S1201). In this case, t=3. Next, the entry number of an empty entry that is needed for file creation is obtained (step S1202). In this case, n=4.

Next, it is judged whether the link destination entry number (t=3) obtained in step S1201 indicates the management entry itself or not (step S1203). In this case, since t=3, i.e., the link destination entry number indicates the management entry itself, the process goes to step S1204, and the entry number obtained in step S1202 is recorded in each of the first 4 bytes (1001) and the subsequent 4 bytes (1002) of the entry of the file to be creased (step S1204). In this case, since n=4, the name of the file to be created becomes “00040004”.

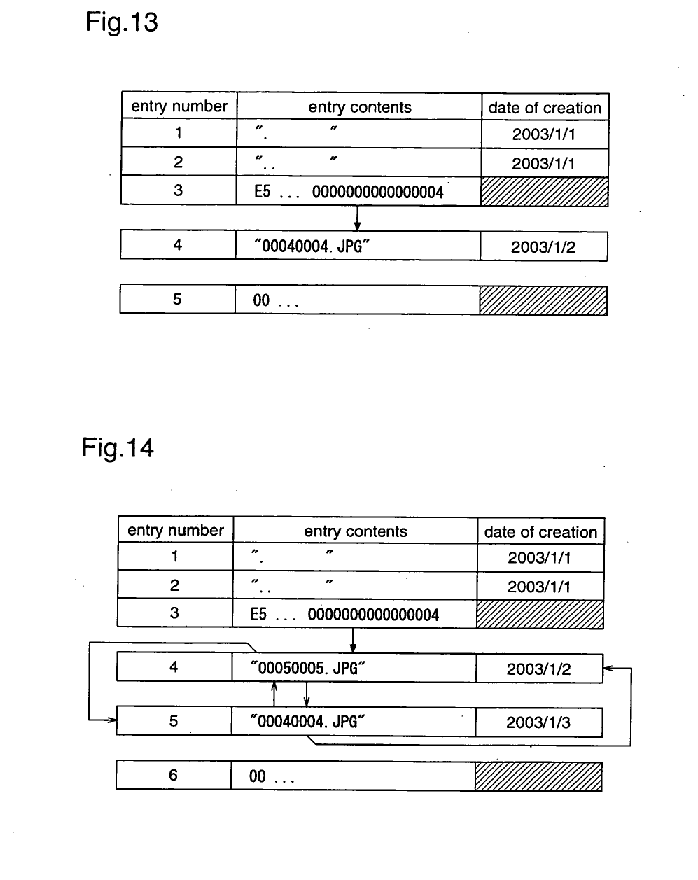

Finally, the entry number obtained in step S1202 is recorded also in the link destination entry number of the management entry (entry number “3”) (step S1205) to complete the entry updation process. The extension of the new file is expressed by “JPG”, and the entry structure after file creation is shown in FIG. 13. It is ensured in FIG. 13 that a link is created between the management entry (entry number “3”) and the file.

The procedure of creating another file from this state will be described with reference to FIG. 12. When file creation is started, the link destination entry number in the management entry (third entry) is obtained (step S1201). In this case, t=4. Next, the entry number of an empty entry that is needed for file creation is obtained (step S1202). In this case, n=5.

Next, it is judged whether the link destination entry number obtained in step S1201 indicates the management entry itself or not (step S1203). In this case, since t=4, i.e., the obtained entry number indicates an entry number other than the management entry (entry number “3”), the process goes to step S1206, and the first 4 bytes of the entry of the entry number obtained in step S1201 is obtained. In this case, l=4.

Next, the entry number obtained in step S1206 is recorded in the first 4 bytes (1001) of the entry of the file to be creased, and the entry number obtained in step S1201 is recorded in the subsequent 4 bytes (1002). In this case, since l=4 and t=4, the name of the file to be creased becomes “00040004”.

Next, the entry number obtained in step S1202 is recorded in the subsequent 4 bytes (1002) of the entry of the entry number obtained in step S1206.

Finally, the entry number obtained in step S1202 is recorded in the first 4 bytes (1001) of the entry of the entry number obtained in step S1201. In this case, since l=4 and t=4, the name of the file of the fourth entry is changed to “00050005”.

Also in this case, the extension of the new file is expressed by “JPG”, and the entry structure after file creation is shown in FIG. 14. It is ensured in FIG. 14 that a reciprocal link between the files is newly created.

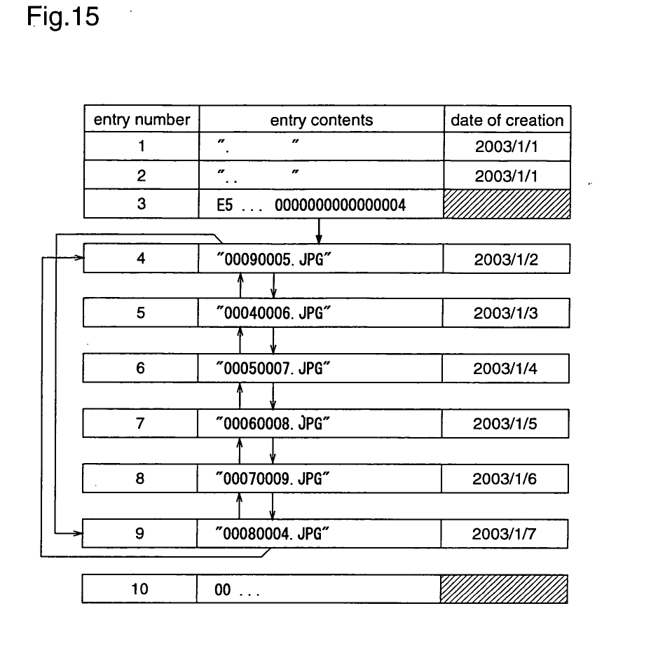

FIG. 15 shows the state where the procedure shown in FIG. 12 is repeated four times to create 6 files in total. Also in this state, it is ensured that a reciprocal link is created between the files, and a link between the management entry (entry number “3”) and the oldest file is created.

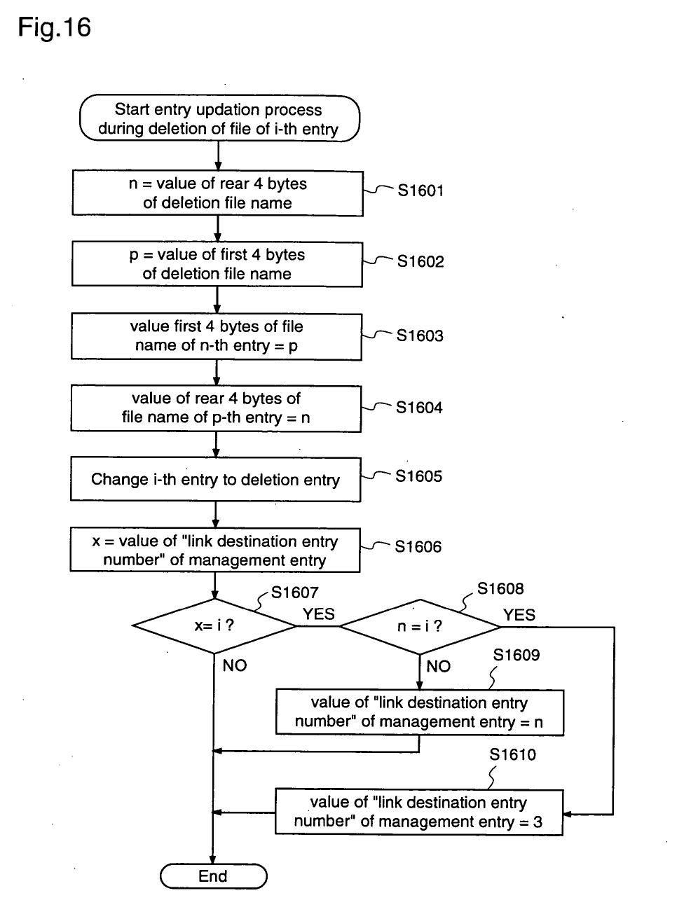

FIG. 16 is a flowchart illustrating an entry updation process to be performed during file deletion. The purpose of performing entry updation in the procedure shown in FIG. 16 is to maintain the above-mentioned two links, i.e., the reciprocal link between the files and the link between the management entry and the target file. Hereinafter, an entry updation process in the case of deleting the file of the sixth entry in the directory shown in FIG. 15 will be described on the basis of the flowchart shown in FIG. 16.

Since the entry number “i” of the file to be deleted is “6” (i=6), the name of the file is “00050007”. Then, the second 4 bytes (1002) and the first 4 bytes (1001) of the entry to be deleted are obtained (step S1601, step S1602). In this case, n=7 and p=5.

Next, the p is recorded in the first 4 bytes (1001) of the n-th entry (step S1603), and the n is recorded in the subsequent 4 bytes (1002) of the p-th entry (step S1604). Next, the contents of the entry to be deleted is changed to a deletion entry (step S1605). Next, the link destination entry number in the management entry is obtained (step S1606), and it is judged whether the obtained entry number matches the entry number of the deletion file or not (step S1607). In this case, since x=4 and i=6, there is no match, and the file deletion process is ended.

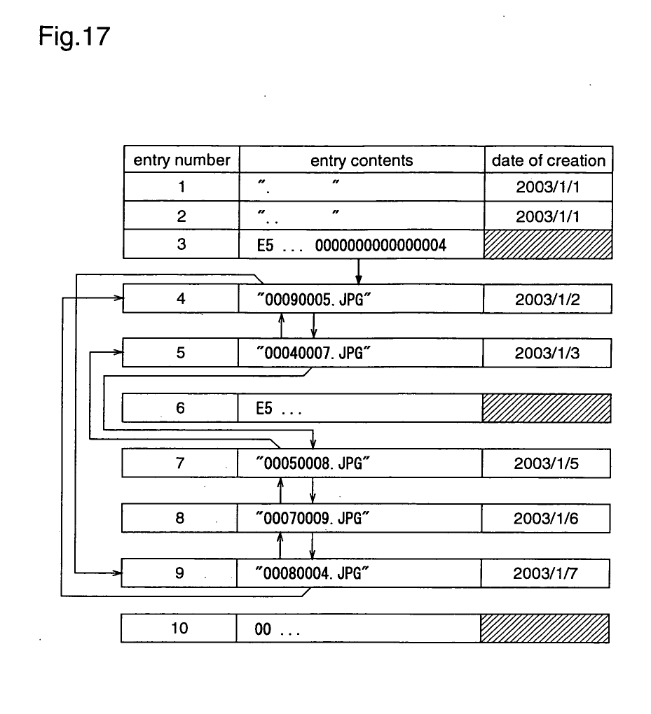

FIG. 17 shows the entry structure after the file deletion. It is confirmed from FIG. 17 that the reciprocal link between the files and the link between the management entry and the target file are maintained.

Next, an entry updation process in the case of deleting the fourth entry which is the oldest file in the directory will be described with reference to FIG. 16.

Since the entry number “i” of the file to be deleted is “4” (i=4), the name of the file to be deleted is “00090005”. Initially, the second 4 bytes (1002) and the first 4 bytes (1001) of the entry to be deleted are obtained (step S1601, step S1602). In this case, n=5 and p=9. Next, the p is recorded in the first 4 bytes (1001) of the n-th entry (step S1603), and the n is recorded in the subsequent 4 bytes (1002) of the p-th entry (step S1604).

Next, the contents of the entry to be deleted is changed to a deletion entry (step S1605). Next, the link destination entry number in the management entry is obtained (step S1606), and it is judged whether the obtained entry number matches the entry number of the deletion file or not (step S1607). In this case, since x=4 and i=4, there is a match.

Next, in step S1608, the n obtained in step S1601 is compared with the entry number “i” of the deletion file to check whether there remains a retrieval target file in the directory or not. In this case, since n=5 and i=4, there is no match between these entry numbers, and it is judged that a retrieval target file remains in the directory. So, the n is recorded in the link destination entry number in the management entry (step S1609) to change the link destination of the management entry to the file which has been created directly after the deletion file.

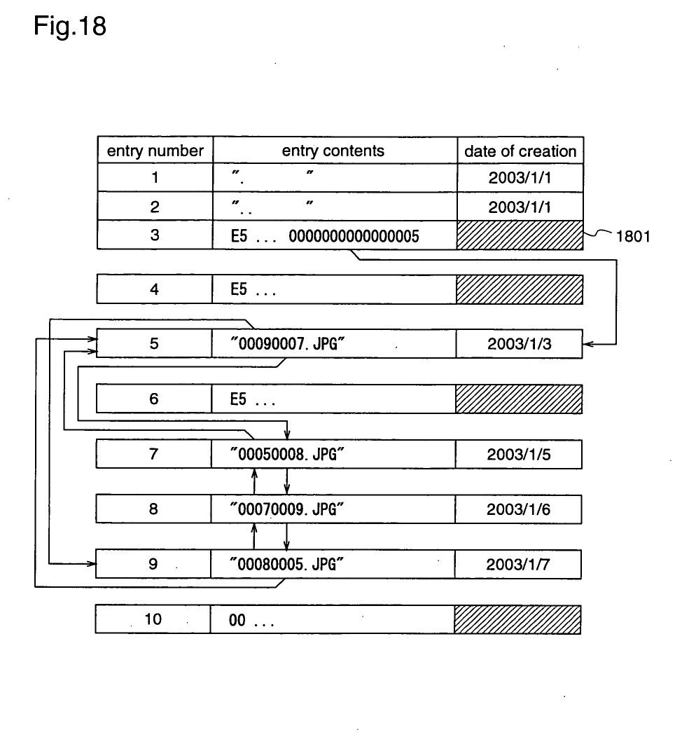

FIG. 18 shows the entry structure after the file deletion. It is confirmed from FIG. 18 that the reciprocal link between the files and the link between the management entry and the target file are maintained.

Next, an entry updation process in the case of deleting the fourth entry in the directory shown in FIG. 13 will be described with reference to FIG. 16. Since the entry number “i” of the file to be deleted is “4” (i=4), the name of the file to be deleted is “00040004”. Then, the second 4 bytes (1002) and the first 4 bytes (1001) of the entry to be deleted are obtained (step S1601, step S1602). In this case, n=4 and p=4.

Next, the p is recorded in the first 4 bytes (1001) of the n-th entry (step S1603), and the n is recorded in the second 4 bytes (1002) of the p-th entry (step S1604). Next, the contents of the entry to be deleted is changed to a deletion entry (step S1605). Then, the link destination entry number in the management entry is obtained (step S1606), and it is judged whether the obtained entry number matches the entry number of the deletion file or not (step S1607). In this case, since x=4 and i=4, there is a match.

Next, the n obtained in step S1601 is compared with the entry number “i” of the deletion file (step S1608) to check whether there remains a retrieval target file in the directory or not. In this case, since n=4 and i=4, there is a match between the entry numbers, and no retrieval target file remains in the directory. Accordingly, “3” which is the entry number of the management entry itself is recorded in the link destination entry number in the management entry (step S1610).

FIG. 11 shows the entry structure after the file deletion. It is confirmed in FIG. 11 that there remains no retrieval target file in the directory, and the link destination of the management entry is set at the management entry itself.

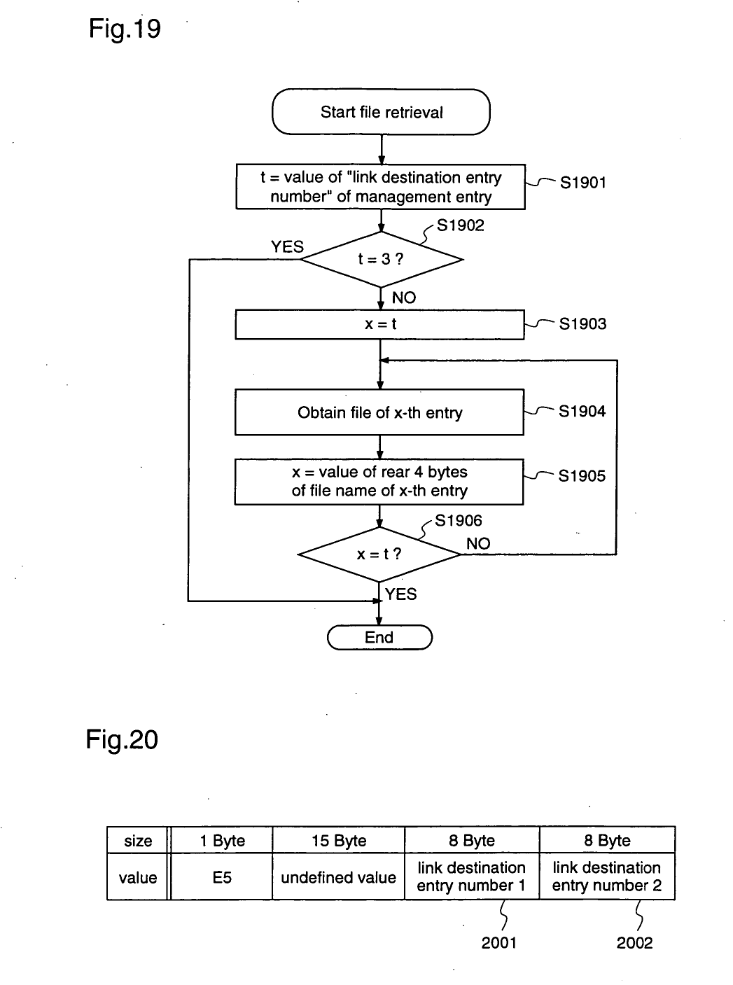

FIG. 19 is a flowchart illustrating a file retrieval process. Initially, a description will be given of the case where the directory shown in FIG. 11 is searched for a file according to the procedure shown in FIG. 19.

When file retrieval is started, the link destination entry number in the management entry is obtained (step S1901), and it is judged whether the obtained entry number indicates the management entry itself or not (step S1902). In this case, since there is no retrieval target file in the directory shown in FIG. 11, t=3, i.e., the obtained entry number matches the management entry itself, and the file retrieval process is ended.

Next, a file retrieval process in the directory shown in FIG. 18 will be described using FIG. 19 again. When file retrieval is started, the link destination entry number in the management entry is obtained (step S1901), and it is judged whether the obtained entry number indicates the management entry itself or not (step S1902). In this case, since t=5, there is no match, and the value x indicating the retrieval position is set to t. In this case, x=5 (step S1903).

Next, the entry at the retrieval position x is regarded as a retrieval target (step S1904). Further, in order to obtain a next retrieval target, the second 4 bytes (1002) of the entry at the current retrieval position x are obtained, and the obtained value is regarded as a next retrieval position x (step S1905). Next, it is judged whether the retrieval position x matches the entry t obtained in step S1901 or not (step S1906). In this case, since x=7 and t=5, there is no match, and the process goes back to step S1904 wherein the entry at the retrieval position x is regarded as a retrieval target.

Hereinafter, this process will be carried out in the following procedure.

Since the retrieval position x=7, a file of the seventh entry is obtained in step S1904. Since the name of the file of the seventh entry is “00050008”, x=8 in step S1905. Accordingly, the judgement in step S1906 as to whether “t=x?” becomes “8=5?” or not. Since the result is “No”, the process goes back to step S1904.

Since the retrieval position x=8, the file of the eighth entry is obtained in step S1904. Since the name of the file of the eighth entry is “00070009”, x=9 in step S1905. Accordingly, the judgement as to whether “t=x?” in step S1906 becomes “9=5?”. Since the result is “No”, the process goes back to step S1904.

Since the retrieval position x=9, the file of the ninth entry is obtained in step S1904. Since the name of the file of the ninth entry is “00080005”, x=5 in step S1905. Accordingly, the judgement as to whether “t=x?” in step S1906 becomes “5=5?”. Since the result is “Yes”, the retrieval is ended.

As described above, the files obtained by the retrieval process are 5, 7, 8, and 9 in order of entry numbers. The dates of creation of the files of these entries are, as shown in FIG. 18, 2003/1/3, 2003/1/5, 2003/1/6, 2003/1/7, and therefore, it is ensured that the files are retrieved in order of creation dates.

As described above, in the file management method according to the second embodiment, the management entry 1103 is recorded in a predetermined position, and the entry number of the oldest file is recorded in this entry. Further, in the entry of each file, the entry number of a file which has been created directly after the corresponding entry is recorded to create reciprocal links in sequence of creation dates between the management file and the retrieval target file and between the respective files, whereby the files can be speedily obtained in a predetermined order. Further, when a file is deleted, the number of files to be renamed does not depend on the number of files in the directory, and therefore, the renaming process can be speedily carried out.

### Embodiment 3

Next, a file management method according to a third embodiment of the present invention will be described. The file management method according to the third embodiment is obtained by combining the file management method of the first embodiment and the file management method of the second embodiment.

Therefore, entries to be managed in this third embodiment are a management entry, a deletion entry, an unused (empty) entry, and a retrieval target file. The data structures of the entries other than the management entry are identical to those described for the first and second embodiments.

FIG. 20 shows the data structure of the management entry according to the third embodiment. As shown in FIG. 20, two link destination entry numbers are recorded in the management entry according to the file management method of the third embodiment. As one of the two entry numbers (2001), like the link destination entry number of the management entry according to the first embodiment, the link destination entry number indicating the position information of another deletion entry or the final entry in the corresponding directory is recorded to be managed. As the other entry number (2002), like the link destination entry number of the management entry of the second embodiment, the entry number of the oldest file is recorded to be managed.

Further, a directory creation process according to the third embodiment is similar to those described for the first and second embodiments, that is, a management entry is created in the third entry.

Furthermore, an entry updation process to be performed during file creation or file deletion according to the third embodiment is similar to the entry updation processes described for the first and second embodiments.

Thereby, even when there are many files in the directory, retrieval of an empty entry or retrieval of files in a predetermined order can be carried out speedily.

As described above, in the file management method according to the third embodiment, the management entry is recorded in a predetermined position, and the link destination entry number indicating the position information of another deletion entry or the final entry in the directory is recorded in one (2001) of the link destination entry numbers. Therefore, when creating or deleting a file, the latest link can be created among the management entry, the deletion entry, and the unused entry. Therefore, even when a deletion entry or an unused entry is located in a backward position in the directory, these entries can be speedily detected during file creation.

Further, the management entry is recorded in a predetermined position, and the entry number of the oldest file is recorded as a link destination number. Therefore, a reciprocal link in sequence of date is created between the management entry and the retrieval target file, whereby files can be speedily obtained in a predetermined order. Further, the number of files to be renamed when a file is renamed does not depend on the number of files in the directory, whereby the renaming process can be speedily carried out.

In the file management method according to the present invention, a management entry is recorded in a predetermined position, and data relating to the management entry and a file deletion destination entry of a file to be deleted or a file creation destination entry of a file to be created are updated during file creation or deletion, whereby the latest link is created among the management entry, the deletion entry, and the unused entry. So, even when there are many files in the directory, retrieval of an empty entry can be speedily carried out, and further, retrieval of files in a predetermined order can be speedily carried out. Therefore, this file management method is suitable for an information devices dealing with many files.

1. A file management method for managing data stored in a storage medium in file units each having a hierarchical structure called a directory, and managing the data using entries which provide a map indicating files in the directory and physical positions of subdirectories on the storage medium,
wherein, in a part of an area assigned to an empty entry, link information indicating the position of another empty entry is recorded.

2. A file management method for managing data stored in a storage medium in file units each having a hierarchical structure called a directory, and managing the data using entries which provide a map indicating files in the directory and physical positions of subdirectories on the storage medium,
wherein the name of a file indicates link information to entries of files which are located before and after the file in the order in which the files are retrieved.

3. A file management method as defined in claim 1,
wherein information indicating the position of a head empty entry is recorded in a predetermined entry area.

4. A file management method as defined in claim 2,
wherein information indicating the position of an entry of a head file is recorded in a predetermined entry area.

5. A file management method as defined in claim 3,
wherein a format in which the information indicating the position of the head empty entry in the predetermined entry area has compatibility with a FAT file system based on JIS-X-0605.

6. A file management method as defined in claim 3,
wherein the position information and the link information are updated when a file is created on or deleted from the storage medium.

7. A file management method as defined in claim 3,
wherein, when a directory is created on the storage medium, the information indicating the position of the head empty entry is recorded in the directory.

8. A file management method as defined in claim 4,
wherein, when a directory is created on the storage medium, the position information indicating the position of the entry of the head file is recorded in the directory.

9. A file management method as defined in claim 4,
wherein the position information and the link information are updated when a file is created on or deleted from the storage medium.
